(19) United States
(12) Patent Application Publication
(10) Pub. No.: US 2003/0015990 A1
(43) Pub. Date: Jan. 23, 2003

(54) In line charge controller for photovaltaic modules

(75) Inventors: Garland Ermis, Thousand Oaks, CA (US); Clay Aldrich, Woodland Hills, CA (US)

Correspondence Address: Siemens Corporation, Attn: Elsa Keller, Legal Administrator, Intellectual Property Department, 186 Wood Avenue South, Iselin, NJ, 08830, US

(73) Assignee: Siemens Information and Communication Networks, Inc.

(21) Appl. No.: 09/910,315

(22) Filed: Jul. 19, 2001

(51) Int. Cl. H02J 7/00; H02J 7/32; H02J 7/35; H01M 10/44; H01M 10/46

(52) U.S. Cl. 320/101

(57) ABSTRACT

An in-line charge controller for controlling charging of a storage device such as a cell, battery or the like by a charging system, particularly a photovoltaic charging system is disclosed. In an exemplary embodiment of the invention, a cable assembly for a photovoltaic charging system including a photovoltaic module suitable for charging a battery, includes a wire assembly for coupling the photovoltaic module to the battery and a charge controller for controlling charging of the battery by the photovoltaic module. The charge controller is embedded in line within the wire assembly thereby reducing the risk of damage to the system or battery due to improper installation of the system.

### BACKGROUND OF THE INVENTION

1. Field of the Invention

The present invention relates generally to systems suitable for use in charging storage devices such as batteries or the like utilizing photovoltaic modules capable of generating electricity from electromagnetic radiation, and more particularly to an inline charge controller for controlling charging of batteries by such photovoltaic charging systems.

2. Description of the Related Art

Photovoltaic charging systems utilize photovoltaic (solar) modules containing one or more photovoltaic cells capable of converting electromagnetic radiation, particularly sunlight into electricity that may then be used for charging a storage device such as a battery, or the like. Because such systems have the potential for overcharging, and thereby damaging the battery, it is desirable to provide a charge controller capable of controlling the flow of electricity between the low wattage photovoltaic module and the battery.

If the charge controller is provided as a separate stand alone component, the user or an installer must connect the charge controller to the photovoltaic module and the battery during installation of the photovoltaic charging system. However, when installation is performed by an untrained user, wiring of the photovoltaic charging system may become confusing creating the possibility that the charge controller may be improperly connected. Such improper connection has the potential of causing damage to the charge controller, photovoltaic module or battery, and injury to the user should such improper connection cause the battery to be overcharged to the point of combustion.

Consequently, it is desirable to provide an in-line charge controller for controlling the charging of a storage device such as a cell, a battery, or the like by a charging system, particularly a photovoltaic charging system. In this manner, the charge controller is provided as a non-obtrusive part of the cable assembly that the user or installer does not have to separately connect when installing the charging system.

### SUMMARY OF THE INVENTION

Accordingly, the present invention is directed to an in-line charge controller for controlling the charging of a storage device such as a cell, battery or the like by a charging system, particularly a photovoltaic charging system. In an exemplary embodiment, a cable assembly for a photovoltaic charging system including a photovoltaic module suitable for charging a battery, includes a wire assembly for coupling the photovoltaic module to the battery and a charge controller for controlling charging of the battery by the photovoltaic module. The charge controller is embedded in line within the wire assembly thereby reducing the risk of damage to the system or battery due to improper installation.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous objects and advantages of the present invention may be better understood by those skilled in the art by reference to the accompanying figures in which:

FIG. 1 is a diagrammatic top plan view of a photovoltaic charging system suitable for charging a battery in accordance with an exemplary embodiment of the present invention, wherein the system includes a photovoltaic module employing crystalline silicon photovoltaic cells;

FIG. 2 is a diagrammatic top plan view of a photovoltaic charging system suitable for charging a battery in accordance with an exemplary embodiment of the present invention, wherein the system includes a photovoltaic module employing a Copper Indium Diselenide (CIS) photovoltaic cell;

FIG. 3 is a top plan view of the in-line charge controller of the photovoltaic charging system shown in FIGS. 1 and 2; and

FIG. 4 is a circuit diagram of an exemplary charge controller circuit suitable for use by the charge controller shown in FIG. 3.

### DETAILED DESCRIPTION OF THE INVENTION

Reference will now be made in detail to the presently preferred embodiments of the invention, examples of which are illustrated in the accompanying drawings.

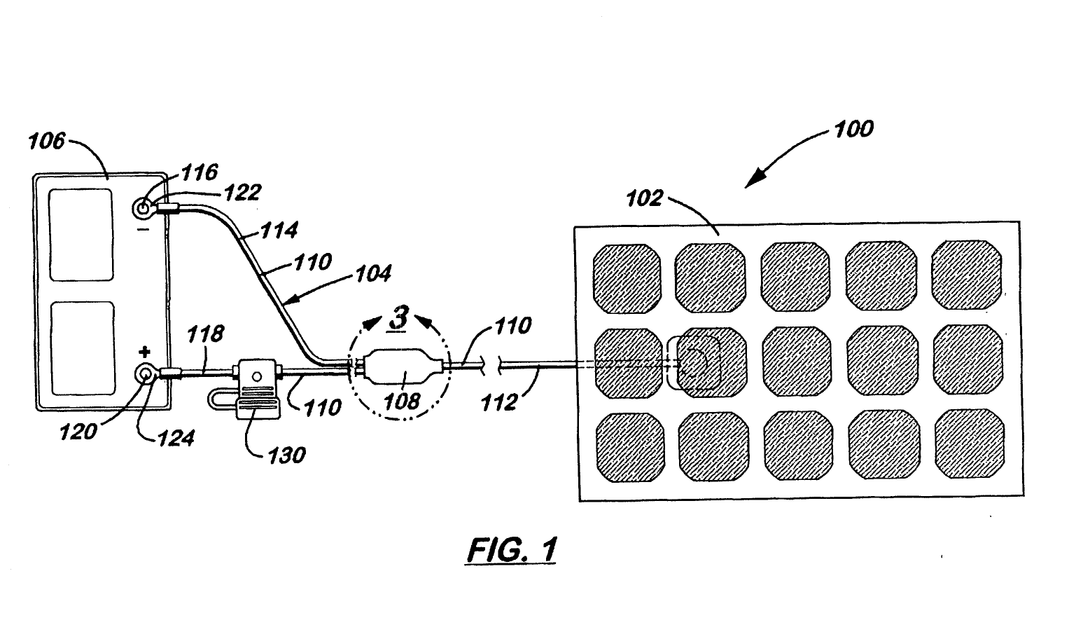

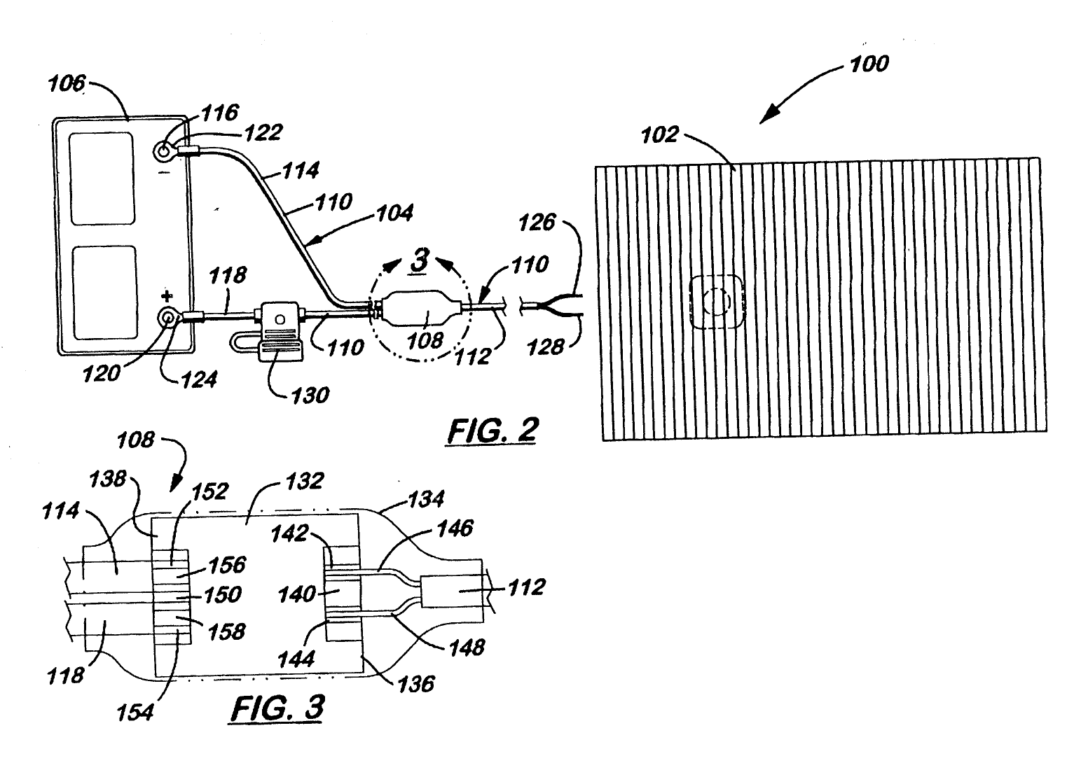

Referring now to FIGS. 1 and 2, a photovoltaic charging system in accordance with an exemplary embodiment of the present invention is described. The photovoltaic charging system 100 includes a photovoltaic (solar) module 102 and a cable assembly 104 for coupling the photovoltaic module 102 to a rechargeable storage device such as a cell or battery 106. In accordance with the present invention, the cable assembly 104 includes an in-line charge controller 108 embedded therein for controlling charging of the battery 106 by the photovoltaic module 102. Preferably, the charge controller 108 controls the flow of electricity between the photovoltaic module 102 and the battery 106 for preventing the photovoltaic module 102 from overcharging or draining the battery 106.

Photovoltaic module 102 may include one or more photovoltaic cells capable of generating electricity from electromagnetic radiation such as light, particularly sunlight. In exemplary embodiments, the photovoltaic module 102 may be comprised of one or more crystalline silicon type cells, as shown in FIG. 1, or one or more Copper Indium Diselenide (CIS) thin-film type cells, as shown in FIG. 2. However, it will be appreciated that other types of photovoltaic cells may be utilized by the photovoltaic module 102 without departing from the scope and spirit of the invention.

Cable assembly 104 further includes a wire assembly 110 for coupling the charge controller 108 to the photovoltaic module and battery 106. In exemplary embodiments of the invention, this wire assembly 110 is comprised of a module wire assembly 112 suitable for extending between the charge controller 108 and the photovoltaic module 102, a ground wire assembly 114 suitable for extending between the charge controller 108 and a ground such as the ground terminal 116 of battery 106, and a load wire assembly 118 for coupling the charge controller to a load such as the positive terminal 120 of battery 106. As shown in FIGS. 1 and 2, ground wire assembly 114 and load wire assembly 118 may each be terminated in a suitable connector 122 & 124 for coupling the cable assembly 104 to ground and load (e.g., to the negative and positive terminals of the battery 116 & 120). Similarly, as shown in FIG. 2, module wire assembly 104 may include a connecting apparatus such as load and ground wire leads 126 & 128, or the like, for coupling the cable assembly 104 to the photovoltaic module 102.

In embodiments of the invention, cable assembly 104 may further include an over-current protection device 130 such as a fuse assembly, or the like, for protecting the photovoltaic charging system 100 and battery 106 from damage caused by excess current. As shown in FIGS. 1 and 2, the over-current protection device 130, in this case a fuse assembly, may be mounted in line within load wire assembly 118.

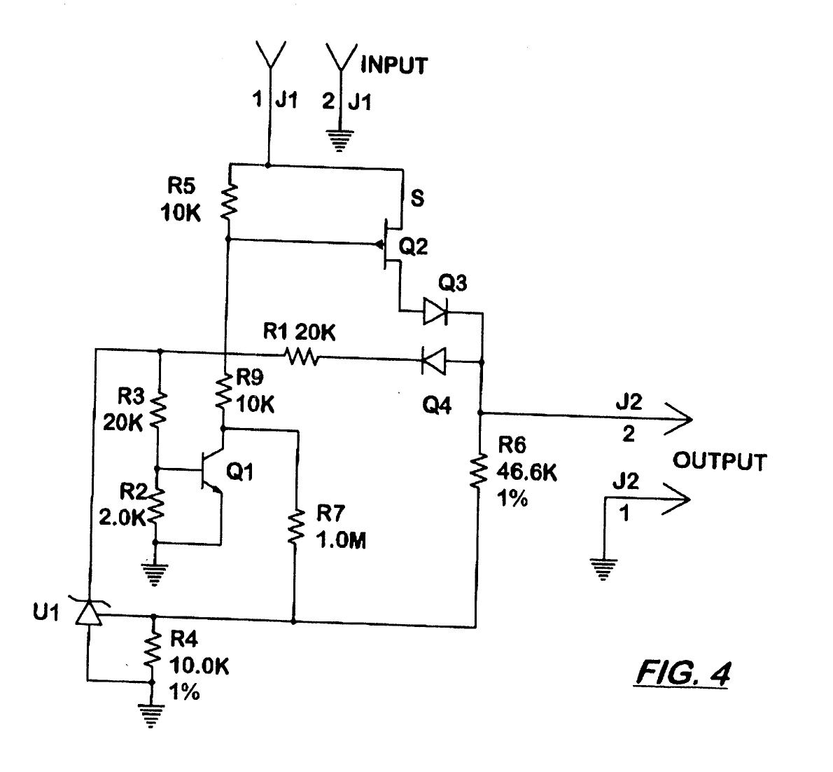

Referring now to FIG. 3, the construction of an exemplary in-line charge controller in accordance with the present invention is described. As shown in FIG. 3, charge controller 108 is comprised of a circuit board 132 supporting circuitry (see FIG. 4) for controlling charging of the battery 106. A cover 134 surrounds the circuit board 132 for protecting it from damage due to mishandling, electromagnetic interference (EMI), and the like. Preferably, the cover 134 fits tightly to the module wire assembly 112, ground wire assembly 114, and load wire assembly 118 for substantially preventing exposure of the circuit board 132 to environmental contaminants. In exemplary embodiments, cover 134 may be formed of a heat shrink material such as a thermoset plastic. However, it is contemplated that other materials (e.g., thermoplastic materials, rubber, nylon) may be utilized to form cover 134 by those of skill in the art.

As shown in FIG. 3, the charge controller circuit is arranged on the circuit board 132 so that the charge controller 108 may be embedded in line in the cable assembly 104 (FIGS. 1 and 2). For instance, in one embodiment, an exemplary circuit board 132 may include a first end 136 and a second end 138 opposite the first end 136 along wire assembly 110 (FIGS. 1 and 2). A first connector portion 140 is formed in the first end 136 or circuit board 132 providing connector pads 142 & 144 to which ground and load leads 146 & 148 of module wire assembly 112 are coupled. Similarly, a second connector portion 150 is formed in the second end 138 of circuit board 132 providing connector pads 152 & 154 to which leads 156 & 158 of ground wire assembly 114 and load wire assembly 118 are coupled.

As can be seen from FIGS. 1, 2 and 3, by arranging connector portions 140 & 150 at opposite ends 136 & 138 of circuit board 132 along wire assembly 110, the present invention allows the circuit board 132 to be embedded in line in the wire assembly 110. For instance, in one embodiment, circuit board 132 formed so that it is approximately 3.175 centimeters long by 2.54 centimeters wide. When covered by cover 134, the circuit board 132 appears as a flattened protrusion or “bump” in the cable assembly 104. This protrusion is preferably of such sufficiently small size that it does not interfere with installation of the photovoltaic charging system 100. In this manner, the charge controller 108 comprises an integral part of the cable assembly 102. Thus, the user or installer does not have to separately connect the charge controller by wiring the photovoltaic module to the controller and the controller to the battery when installing the photovoltaic charging system. In this manner, the present invention eliminates confusion to the user or installer, and helps to insure proper installation of the photovoltaic charging system reducing the risk of damage to the system or battery and injury to the user or installer.

Turning now to FIG. 4, an exemplary charge controller circuit suitable for implementation on circuit board 132 (FIG. 3) is described. The charge controller circuit controls the flow of electricity between the photovoltaic module 102 and the battery 106 for preventing the photovoltaic module 102 from overcharging the battery 106 (see FIGS. 1 and 2). As shown in FIG. 4, the charge controller circuit includes a series switch and a voltage sensor for sensing the voltage of the battery 106 and controlling operation of the switch in response thereto. When the voltage sensor senses that the battery voltage is greater than a first or lower threshold voltage but less than a second or higher threshold voltage, the switch between the photovoltaic module 102 and the battery 106 is closed, allowing the photovoltaic module 102 to charge the battery 106. However, when the voltage sensor senses that the battery voltage has increased to the second threshold voltage, the switch is opened, disconnecting the photovoltaic module 102 from the battery 106 to prevent overcharging of the battery 106. After the switch is opened, the voltage sensor again monitors the battery voltage. If the voltage drops to less than a third or intermediate threshold voltage, the switch is again closed and remains closed until the battery voltage is again increased to the second threshold voltage.

FIG. 4 illustrates an embodiment of the charge controller circuit suitable for use with a 12 volt battery wherein the first threshold voltage is approximately 8 volts, the second threshold voltage is approximately 13.9 volts, and the third threshold voltage is approximately 12.5 volts. Thus, under conditions where the battery voltage is greater than approximately 8 volts (the first threshold voltage) but less than approximately 13.9 volts (the second threshold level), the switch between the photovoltaic module 102 and the battery 106 is closed so that the battery 106 may be charged. When the battery voltage increases to 13.9 volts (the second threshold voltage), the switch is opened, disconnecting the photovoltaic module 102 and battery 106. Finally, when the battery voltage drops to less than 12.5 volts (the third threshold voltage), the switch again closes and remains closed until the battery voltage is again increased to 13.9 volts (the second threshold level).

As can be seen from FIG. 4, the controller circuit will not charge a completely dead or shorted battery. In this manner, damage to the charge controller is avoided. Further, a diode is provided in the charge controller circuit for preventing the photovoltaic module 102 from draining the battery 106, for example, when the photovoltaic module 102 is in darkness.

FIG. 4 illustrates one embodiment of a charge controller circuit in accordance with the present invention. However, it will be appreciated by those of skill in the art that the components shown in FIG. 4 may be resized depending on the voltage of the battery or batteries being charged. Further, it will be appreciated that based on the present disclosure, charge controller circuits capable of performing the functions of the charge controller circuit shown in FIG. 4 may be constructed wherein the components of the circuit are rearranged or other components added to or substituted for those specifically shown in FIG. 4. Consequently, substitution of such circuits for the charge control circuit shown in FIG. 4 is considered within the scope and spirit of the present invention as defined by the appended claims.

It is believed that the in-line charge controller of the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A cable assembly for a charging system suitable for charging a storage device, comprising:
a wire assembly for coupling the storage device to a voltage source for charging the storage device; and
a charge controller for controlling charging of the storage device by the voltage source;
wherein the charge controller is embedded in line in the wire assembly.

2. The cable assembly as claimed in claim 1, wherein the voltage source comprises a photovoltaic module.

3. The cable assembly as claimed in claim 1, wherein the charge controller comprises:
a circuit board including a charge control circuit for controlling charging of the storage device; and
a cover for substantially surrounding the circuit board;
wherein the circuit is arranged on the circuit board so that the circuit board may be embedded in line in the wire assembly.

4. The cable assembly as claimed in claim 3, wherein the wire assembly comprises:
a module wire assembly for coupling the voltage source to the circuit board;
a ground wire assembly for coupling the circuit board to a ground; and
a load wire assembly for coupling the circuit board to a positive terminal of the storage device.

5. The cable assembly as claimed in claim 4, wherein the circuit board comprises:
a first end including a first connector portion suitable for connection of the module wire assembly;
a second end opposite the first end, the second end including a second connector portion suitable for connection of the ground wire assembly and the load wire assembly;
wherein the first and second connector portions are positioned on the circuit board so that the circuit board is embedded in line in the wire assembly.

6. The cable assembly as claimed in claim 3, wherein the cover fits tightly to the wire assembly for substantially preventing exposure of the circuit board to environmental contaminants.

7. The cable assembly as claimed in claim 3, wherein the cover comprises a heat shrink material.

8. The cable assembly as claimed in claim 1, wherein the wire assembly further includes a fuse assembly.

9. A cable assembly for a photovoltaic charging system including a photovoltaic module suitable for charging a battery, comprising:
a wire assembly for coupling the photovoltaic module to the battery; and
a charge controller for controlling charging of the battery by the photovoltaic module;
wherein the charge controller is embedded in line in the wire assembly.

10. The cable assembly as claimed in claim 9, wherein the charge controller comprises:
a circuit board including charge control circuit for controlling charging of the battery; and
a cover for substantially surrounding the circuit board;
wherein the circuit is arranged on the circuit board so that the circuit board may be embedded in line in the wire assembly.

11. The cable assembly as claimed in claim 10, wherein the wire assembly comprises:
a module wire assembly for coupling the photovoltaic module to the circuit board;
a ground wire assembly for coupling the circuit board to a ground; and
a load wire assembly for coupling the circuit board to a positive terminal of the battery.

12. The cable assembly as claimed in claim 11, wherein the circuit board comprises:
a first end including a first connector portion suitable for connection of the module wire assembly;
a second end opposite the first end, the second end including a second connector portion suitable for connection of the ground wire assembly and the load wire assembly;
wherein the first and second connector portions are positioned on the circuit board so that the circuit board is embedded in line in the wire assembly.

13. The cable assembly as claimed in claim 11, wherein the cover fits tightly to the wire assembly for substantially preventing exposure of the circuit board to environmental contaminants.

14. The cable assembly as claimed in claim 10, wherein the cover comprises a heat shrink material.

15. The cable assembly as claimed in claim 9, wherein the wire assembly further includes a fuse assembly.

16. A photovoltaic charging system suitable for charging a battery, comprising:
a photovoltaic module for generating electricity from electromagnetic radiation; and
a cable assembly for coupling the photovoltaic module to the battery, the cable assembly including an embedded in line charge controller for controlling charging of the battery by the photovoltaic module.

17. The photovoltaic charging system as claimed in claim 16, wherein the charge controller comprises:
a circuit board including a charge control circuit for controlling charging of the battery; and
a cover for substantially surrounding the circuit board;
wherein the charge control circuit is arranged on the circuit board so that the circuit board is embedded in line in the wire assembly.

18. The photovoltaic charging system as claimed in claim 17, wherein the cable assembly comprises:
a module wire assembly for coupling the photovoltaic module to the circuit board;
a ground wire assembly for coupling the circuit board to a ground; and
a load wire assembly for coupling the circuit board to a positive terminal of the battery.

19. The photovoltaic charging system as claimed in claim 18, wherein the circuit board further comprises:
a first end including a first connector portion suitable for connection of the module wire assembly;
a second end opposite the first end, the second end including a second connector portion suitable for connection of the ground wire assembly and the load wire assembly;
wherein the first and second connector portions are positioned on the circuit board so that the circuit board is embedded in line in the wire assembly.

20. The photovoltaic charging system as claimed in claim 18, wherein the cover comprises a heat shrink material.

21. The photovoltaic charging system as claimed in claim 18, wherein the cover fits tightly to the module wire assembly, ground wire assembly, and load wire assembly for preventing exposure of the circuit board to environmental contaminants.

22. The photovoltaic charging system as claimed in claim 18, further comprising a fuse assembly mounted in line within the load wire assembly.

23. A cable assembly for a photovoltaic charging system including a photovoltaic module suitable for charging a battery, comprising:
a wire assembly for coupling the photovoltaic module to the battery; and
a charge controller for controlling charging of the battery by the photovoltaic module, the charge controller including a circuit board having a first end and a second end opposite the first end, the first end including a first connector portion and the second end including a second connector portion;
wherein the first and second connector portions are suitable for connecting the circuit board to the wire assembly so that the charge controller (108) is embedded in line in the wire assembly (110).

24. The cable assembly as claimed in claim 23, wherein the charge controller further comprises a cover for substantially surrounding the circuit board.

25. The cable assembly as claimed in claim 24, wherein the cover comprises a heat shrink material.

26. The cable assembly as claimed in claim 24, wherein the cover fits tightly to the wire assembly for substantially preventing exposure of the circuit board to environmental contaminants.

27. The cable assembly as claimed in claim 15, wherein the wire assembly comprises:
a module wire assembly for coupling the photovoltaic module to the circuit board;
a ground wire assembly for coupling the circuit board to a ground; and
a load wire assembly for coupling the circuit board to a positive terminal of the battery.

28. The cable assembly as claimed in claim 27, further comprising a fuse assembly mounted within the load wire assembly.

29. A cable assembly for a photovoltaic charging system including a photovoltaic module suitable for charging a battery, comprising:
means for coupling the photovoltaic module to the battery;
means for controlling charging of the battery; and
means for embedding the charge controlling means in the coupling means.
